(19) United States
(12) Patent Application Publication
(10) Pub. No.: US 2018/0198594 A1
(43) Pub. Date: Jul. 12, 2018

(54) USER DEVICE SIGNAL PROCESSING BASED ON TRIGGERED REFERENCE SIGNALS FOR WIRELESS NETWORKS

(71) Applicant: NOKIA TECHNOLOGIES OY, Espoo (FI)

(72) Inventors: Esa Tapani TIIROLA, Kempele (FI); Kari Pekka PAJUKOSKI, Oulu (FI); Sami-Jukka HAKOLA, Kempele (FI); Jorma Johannes KAIKKONEN, Oulu (FI); Lars DALSGAARD, Oulu (FI); Sigen YE, Whitehouse Station, NJ (US)

(21) Appl. No.: 15/400,540

(22) Filed: Jan. 6, 2017

(51) Int. Cl. H04L 5/26; H04L 5/00; H04W 74/00

(52) U.S. Cl. CPC H04L 5/26; H04W 72/0446; H04W 74/006; H04L 5/0048

(57) ABSTRACT

A technique is provided for receiving, by a user device from a base station, a control signal indicating that base station-triggered reference signals will be transmitted to the user device, and receiving, by the user device, the base station-triggered reference signals on a set of time-frequency resources in at least one physical downlink control channel (PDCCH) search space.

### TECHNICAL FIELD

This description relates to communications, and in particular, to user device signal processing based on triggered reference signals for wireless networks.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3^{rd} Generation Partnership Project (3GPP). A recent development in this field is often referred to as the long-term evolution (LTE) of the Universal Mobile Telecommunications System (UMTS) radio-access technology. S-UTRA (evolved UMTS Terrestrial Radio Access) is the air interface of 3GPP's Long Term Evolution (LTE) upgrade path for mobile networks. In LTE, base stations (BSs) or access points (APs), which are referred to as enhanced Node AP (eNBs), provide wireless access within a coverage area or cell. In LTE, mobile devices, user devices or mobile stations are referred to as user equipments (UEs). Also 5G wireless systems, and new radio (NR) are being developed for 5G.

A downlink control channel, such as a physical downlink control channel (PDCCH), may be used to carry downlink control information (DCI), such as a downlink scheduling assignment(s) (e.g., including resource allocation information and transport format, control information for spatial multiplexing), an uplink scheduling grant(s) (e.g., including resource allocation information and transport format), power control information or power control commands for one or more terminals or UEs, and/or other downlink control information. A reference signal (RS), e.g. a demodulation reference signal (DMRS) or other RS, may also be transmitted by a base station to a user device.

### SUMMARY

According to an example implementation, a method is provided for receiving, by a user device from a base station, a control signal indicating that base station-triggered reference signals will be transmitted to the user device, and receiving, by the user device, the base station-triggered reference signals on a set of time-frequency resources in at least one physical downlink control channel (PDCCH) search space.

According to an example implementation, an apparatus includes at least one processor and at least one memory including computer instructions, when executed by the at least one processor, cause the apparatus to receive, by a user device from a base station, a control signal indicating that base station-triggered reference signals will be transmitted to the user device, receive, by the user device, the base station-triggered reference signals on a set of time-frequency resources in at least one physical downlink control channel (PDCCH) search space, and perform signal processing based on the base station-triggered reference signals.

According to an example implementation, a computer program product includes a non-transitory computer-readable storage medium and storing executable code that, when executed by at least one data processing apparatus, is configured to cause the at least one data processing apparatus to perform a method including: receiving, by a user device from a base station, a control signal indicating that base station-triggered reference signals will be transmitted to the user device, receiving, by the user device, the base station-triggered reference signals on a set of time-frequency resources in at least one physical downlink control channel (PDCCH) search space, and performing synchronization based on the base station-triggered reference signals.

According to an example implementation, a method is provided for determining, by a base station in a wireless network, an event, transmitting, from a base station in response to the event, a control signal indicating that base station-triggered reference signals will be transmitted to the user device, and, transmitting the base station-triggered reference signals on a set of time-frequency resources in at least one physical downlink control channel (PDCCH) search space.

According to an example implementation, an apparatus includes at least one processor and at least one memory including computer instructions, when executed by the at least one processor, cause the apparatus to: determine, by a base station in a wireless network, an event; transmit, from a base station in response to the event, a control signal indicating that base station-triggered reference signals will be transmitted to the user device; and, transmit the base station-triggered reference signals on a set of time-frequency resources in at least one physical downlink control channel (PDCCH) search space.

According to an example implementation, a computer program product includes a non-transitory computer-readable storage medium and storing executable code that, when executed by at least one data processing apparatus, is configured to cause the at least one data processing apparatus to perform a method including: determining, by a base station in a wireless network, an event, transmitting, from a base station in response to the event, a control signal indicating that base station-triggered reference signals will be transmitted to the user device, and, transmitting the base station-triggered reference signals on a set of time-frequency resources in at least one physical downlink control channel (PDCCH) search space.

The details of one or more examples of implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a flow chart illustrating operation of a user device according to an example implementation.

FIG. 3 is a flow chart illustrating operation of a base station according to an example implementation.

FIG. 4 is a diagram illustrating different slot types according to an example implementation.

FIG. 5 is a diagram illustrating control channel (e.g., PDCCH) search spaces for common search space (CSS) and user device-specific search space (USS) according to an illustrative example implementation.

FIG. 6 is a diagram illustrating a transmission of a RF bandwidth switching command during slot n, and transmission of BS-triggered reference signals according to an example implementation.

FIG. 7 is a diagram illustrating a slot-based transmission of a reference signal in CSS and USS according to an example implementation.

FIG. 8 is a diagram illustrating a mini-slot-based transmission of a reference signal in CSS and USS according to an example implementation.

FIG. 9 is a diagram illustrating an exemplary reference signal structure for PDCCH (applicable to both CSS and USS).

FIG. 10 is a block diagram of a node or wireless station (e.g., network device, base station/access point or mobile station/user device/UE) according to an example implementation.

### DETAILED DESCRIPTION

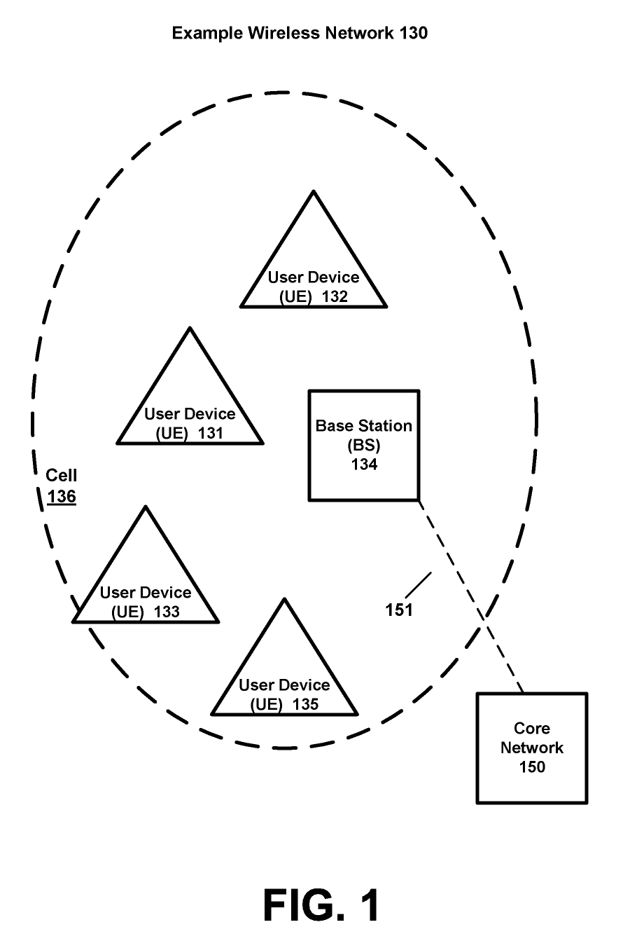

FIG. 1 is a block diagram of a wireless network 130 according to an example implementation. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB (a new radio base station for 5G), or a network node. At least part of the functionalities of an access point (AP), base station (BS) or (e)Node B (eNB) may be also be carried out by any node, server or host which may be operably coupled to a transceiver, such as a remote radio head. BS (or AP) 134 provides wireless coverage within a cell 136, including to user devices 131, 132, 133 and 135. Although only four user devices are shown as being connected or attached to BS 134, any number of user devices may be provided. BS 134 is also connected to a core network 150 via a S1 interface 151. This is merely one simple example of a wireless network, and others may be used.

A user device (user terminal, user equipment (UE) or mobile station) may refer to a portable computing device that includes wireless mobile communication devices operating with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, and a multimedia device, as examples. It should be appreciated that a user device may also be a nearly exclusive uplink only device, of which an example is a camera or video camera loading images or video clips to a network.

By way of illustrative example, the various example implementations or techniques described herein may be applied to various user devices, such as machine type communication (MTC) user devices, enhanced machine type communication (eMTC) user devices, Internet of Things (IoT) user devices, and/or narrowband IoT user devices. IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans.

Also, in an example implementation, a user device or UE may be a UE/user device with ultra reliable low latency communications (URLLC) applications. A cell (or cells) may include a number of user devices connected to the cell, including user devices of different types or different categories, e.g., including the categories of MTC, NB-IoT, URLLC, or other UE category.

In LTE (as an example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks.

The various example implementations may be applied to a wide variety of wireless technologies or wireless networks, such as LTE, LTE-A, 5G, cmWave, and/or mmWave band networks, IoT, MTC, eMTC, URLLC, etc., or any other wireless network or wireless technology. These example networks or technologies are provided only as illustrative examples, and the various example implementations may be applied to any wireless technology/wireless network.

A downlink control channel may be used to carry various control information to a user device or UE. For example, a downlink control channel, such as a physical downlink control channel (PDCCH), may be used to carry downlink control information (DCI), such as a downlink scheduling assignment(s) (e.g., including resource allocation information and transport format, control information for spatial multiplexing), an uplink scheduling grant(s) (e.g., including resource allocation information and transport format), power control information or power control commands for one or more terminals or UEs, and/or other downlink control information. According to an example implementation, a downlink control channel, such as PDCCH, may carry a DCI (or multiple DCIs) each subframe or time slot or a mini-slot.

DCI may apply Polar coding in New radio. For a DCI or other control message/control information, a cyclic redundancy check (CRC bits or parity bits for error detection, or CRC bits for error detection and correction) may be appended to the control payload. According to an example implementation, the control payload (e.g., including DCI) and/or the CRC may be scrambled or encoded based on the user device identifier (e.g., encoded or scrambled based on a radio network temporary identifier or C-RNTI of the user device) to indicate that the control information is addressed to the specific user device (or user group) identified by the C-RNTI. The user device may similarly perform descrambling based on the C-RNTI to determine if the received DCI or other control information is addressed to the user device or not.

The PDCCH may carry control information on an aggregation of one or more control channel elements (CCEs), where a CCE is a set (or fixed size) of time-frequency resources, for example, including some number of resource elements (e.g., 48 resource elements per CCE, or other number of resource elements). The resource elements can be, e.g., subcarriers of an OFDM symbol. According to an illustrative example implementation, the resource elements of CCEs may be divided between DMRS portion and DCI portion, e.g. in such that 25% of the REs (resource elements) are allocated to DMRS and 75% for DCI, respectively. Different aggregation levels may be used for the PDCCH resources used to transmit a DCI or control information. An aggregation level refers to the number of CCEs (or may indicate the amount of resources for the control information), such as a number of consecutive CCEs (aggregated) used to transmit DCI or downlink control information. For example, aggregation levels of 1, 2, 4 and 8 may allocate the indicated number of consecutive CCEs for the transmission of control information. In an example implementation, an aggregation level may be, for example one of the following aggregation levels: aggregation level=1, CCE index #1 (one CCE); aggregation level=2, CCE index #1-#2 (two CCEs); aggregation level=4, CCE index #1-#4 (4 CCEs); aggregation level=8, CCE index #1-#8 (eight CCEs), by way of illustrative example. The number of CCEs (or aggregation level), e.g., one, two, four or eight CCEs for downlink resources to transmit control information, may vary based on a payload size of control information and/or the channel coding rate, and/or other factors, for example.

In some cases, a user device may be required to perform blind decoding of DCI information at a number of different resource locations and/or aggregation levels, which can be time-wise and computationally-wise expensive for a user device. In attempt to reduce the number of required blind decodings of downlink control information, one or more search spaces may be provided for a user device or UE. A search space may be a set of candidate control channels formed by CCEs at a given aggregation level, which the UE is supposed to (or should) attempt to decode. The UE may have multiple search spaces configured for different purposes, such as common search space (CSS) and UE-specific search space (USS) and it may perform blind decoding of DCI information from one or more search spaces in certain subframe or slot or mini-slot.

Search spaces may include user device-specific search spaces (US S) that include information directed to a specific user device or UE, and common search spaces (CS S) that include information directed to a plurality of (or a group of) user devices/UEs.

Therefore, according to an example implementation, a user device-specific search space (USS) may include PDCCHs or control channels that are specifically addressed to a particular user device or UE. For an example USS, a CRC or other field provided within a control channel or PDCCH may be encoded with the UE's RNTI as a way to indicate to which user device/UE the control channel or control information is addressed to. Thus, each UE may have a UE-specific search space (USS) at each of one or more aggregation levels, for example.

In addition, a common search space (CSS) may include control channels or control information transmitted to a plurality or group of UEs. ABS may transmit control information to a plurality (or group) of UEs, such as system information, dynamic scheduling information, transmission of paging messages, transmission of power control messages to a group of UEs via a common search space (CS S). Also, an example wireless network may reduce the amount of blind decoding required for each user device by limiting the number of USS and CSS. For example, a limited set of CCE locations where a PDCCH can be placed may reduce the search spaces for a UE. For example, a limited search space may include, for example, a CSS that includes 6 PDCCH candidates and a USS with 16 candidates, which may need to be decoded twice if there are two possible size options for each aggregation level, e.g., giving a total of 44 blind decoding attempts for a UE, as an illustrative example.

According to an example implementation, a wireless system (e.g., such as 5G or other system) may include a lean carrier design that may minimize or at least reduce the amount of always on, or continuous or periodic signaling, as this type of control signaling (e.g., always on or continuous signaling, periodic signaling) reduces the opportunities of energy savings for a BS, and may create excessive interference. For example, by reducing the amount of reference signals that are transmitted by a BS, this may reduce the reference signal overhead and interference, and may allow improved BS energy savings, but at the cost of decreased synchronization (or other signal processing that may be useful or necessary for the UE) opportunities offered to UEs.

Therefore, according to an example implementation, B S-triggered reference signals (e.g., aperiodic reference signals) are transmitted by the BS, e.g., based on detection or occurrence of an event detected by the BS, where such an event may require reference signals to be transmitted to a UE or group of UEs, e.g., to allow for signal processing functions to be performed by the UE(s). Thus, the BS-triggered transmission of reference signals may provide a leaner design where the BS-triggered reference signals are transmitted based on an event detected by the BS and/or when such reference signals will be needed by a user device/UE. An example reference signal may include demodulation reference signals (DMRS) that are transmitted by a BS to a UE(s) to allow the UE to perform one or more signal processing functions, such as, by way of illustrative example, time synchronization, frequency synchronization, automatic gain control (AGC), channel estimation for (e.g., coherent) demodulation of a physical downlink control channel (PDCCH) (and possibly other channels) and to allow (or assist) the UE to perform decoding on received data or control information, channel tracking, radio resource management (RRM) measurement (e.g., measuring one or more of the following based on the received reference signals: channel quality indicator (CQI), reference signal received power (RSRP), reference signal received quality (RSRQ) and received signal strength indicator (RSSI)), and/or for other signal processing functions at a UE. For example, time and frequency synchronization may include a UE determining a start or timing of a frame, symbol timing, etc. Automatic gain control (AGC) at a UE may include adjusting the gain or amount of amplification to be applied to received signals, for example. One or more of these signal processing functions may need to be updated by a UE from time to time, and the BS-triggered reference signals may provide an opportunity for the UE to perform such signal processing, e.g., even in the case of a lean (or leaner) carrier design where fewer always on or periodic reference signals will be transmitted.

According to an illustrative example implementation, a BS may dynamically adjust an RF (radio frequency or wireless) bandwidth (including the downlink transmission bandwidth) between the BS and a UE based on one or more factors that may be measured or detected by the BS, such as the amount of data in a transmission buffer that is awaiting transmission to a UE. Thus, for example, if a smaller amount of data is in data buffers at the B S (or other location) awaiting downlink transmission to the UE, then a smaller RF bandwidth may be used (e.g., 5 MHz, or fewer subcarriers) by the BS to transmit this data to the UE. On the other hand, if more data is in data buffers of the BS awaiting transmission to the UE, then a larger or greater RF bandwidth (e.g., 20 MHz, or more subcarriers) may be used to transmit data to the UE. The term RF (radio frequency) is not limited to a particular frequency or frequency band, but refers to a radio or wireless transmission bandwidth. According to an example implementation, a UE may be required to perform (or update) time/frequency synchronization and/or perform or update automatic gain control (AGC), or other signal processing, e.g., based on reference signals, anytime the RF (or transmission/wireless) bandwidth for downlink transmission from the B S to the UE is changed, and especially when the RF bandwidth between the BS and UE increases. This is because, for example, whenever the center frequency of an oscillator at the UE changes (e.g., such as based on a different RF bandwidth) or when the RF bandwidth changes, the UE will typically need to re-synchronize and perform updated AGC for the new RF bandwidth and corresponding oscillator frequency, and this may, for example, require receiving reference signals (or preamble), such as DMRS signals, across the full range of frequencies (for the new RF bandwidth) that the UE will be receiving and decoding information.

For example, an AGC block of a UE receiver may vary the gain or amplification of received signals in attempt to provide an approximately constant output level or amplitude (or output levels or amplitudes within a specific range of values) even though the input signal levels may vary. For example, a UE may use received reference signals to adjust the gain performed by the AGC, and thus, assisting with the demodulation of any received signals across a range of frequencies or bandwidth. Thus, for example, if a transmission bandwidth from the BS to the UE changes, the UE may perform AGC again, based on the new DL transmission bandwidth to allow the UE to better perform decoding on control information and data across such new transmission (or RF) bandwidth, as an illustrative example implementation. Similarly, it may be needed or at least desirable for synchronization at a UE be performed again when RF bandwidth (or DL transmission bandwidth) from the BS to the UE changes, to maintain accurate synchronization at the UE, for example.

Therefore, a changed or updated RF (wireless) bandwidth between a BS and UE is an illustrative example of an event that may trigger or cause the BS to transmit BS-triggered reference signals (e.g., BS-triggered DMRS signals) to the UE. BS-triggered reference signals are, or at least may include, aperiodic reference signals that are transmitted to the UE when the BS detects a specific event or when the BS detects that a UE will have a need for such references signals (such as a need to update synchronization or AGC, or other signal processing, based on a changed RF bandwidth, for example), as opposed to reference signals that are periodically or always transmitted, regardless of events detected by the BS. The BS-triggered reference signals may provide a leaner system design that may reduce reference signal overhead, reduce interference between adjacent cells/BSs, and allow improved BS energy savings, e.g., based on the on-demand or BS-triggered reference (e.g., DMRS) signals.

Thus, an illustrative example of an event that may trigger the BS to transmit reference signals to a UE may include, for example, where the BS changes the RF bandwidth for the UE, such as based on a change in amount of data for transmission to the UE (which may cause the BS to dynamically change or adjust the RF bandwidth based on the amount of data for transmission to the UE). This is merely one illustrative example, and there may be other events, which may be detected by the BS, which my trigger or cause the BS to transmit reference signals, such as DMRS signals, to a UE. According to an example implementation, a user device may receive from a BS a control signal indicating that BS-triggered reference signals will be transmitted to the user device. The user device may receive the reference signals, and may then perform signal processing (e.g., time synchronization to determine timing of a frame, subframe, time slot, symbol, and/or frequency synchronization) and/or automatic gain control (AGC), channel estimation, or other signal processing functions, based on the received BS-triggered reference signals (e.g., BS-triggered DMRS signals). In an example implementation, the received control signal may indicate one or more resources for the transmission of the BS-triggered reference signals.

According to an example implementation, the control signal may also indicate when reference signals are present (e.g., indicating which slot/mini-slot, and for which OFDM symbols), format of the reference signals (e.g., a number of antenna ports for RS) and on which resource elements (e.g., CSS only or CSS+USS). In an example implementation, a part of the indication can be provided (or control signals may be sent via) by semi-static higher layer signaling (e.g., via radio resource control/RRC signaling), and another part via dynamic signaling (e.g., PDCCH DCI) or MAC control element (for example).

According to an example implementation, the reference signals (RSs) may include demodulation reference signals (DMRS signals) by way of illustrative example or other RSs, and the RSs may be transmitted across the bandwidth (e.g., some reference signals will be transmitted via some or across a range or plurality of subcarriers or frequency resources of the new/updated RF bandwidth) of the new or updated (changed) RF bandwidth (changed transmission bandwidth) for the user device. The control signal may, for example, may be transmitted to the user device via PDCCH downlink control information (DCI) or as or within a MAC (media access control) control element or field, or within other control signal. In an example implementation, the reference signals may be received via predefined time-frequency resources of a physical downlink control channel (PDCCH) common search space (CSS) or user device-specific search space (USS).

### Example 1

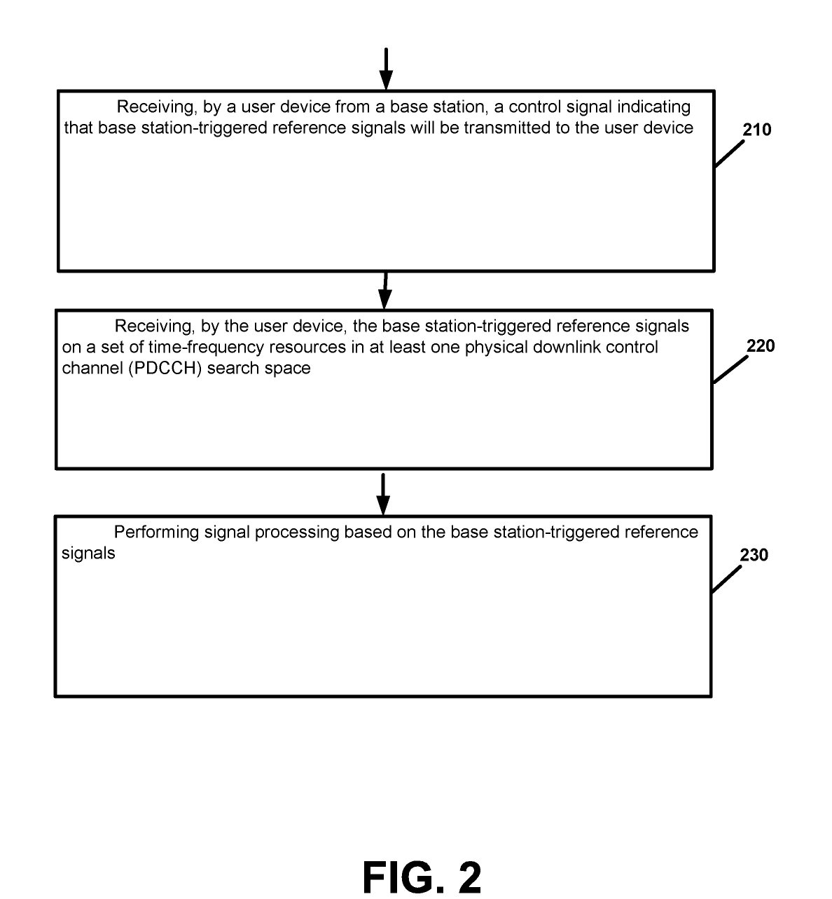

FIG. 2 is a flow chart illustrating operation of a user device according to an example implementation. Operation 210 includes receiving, by a user device from a base station, a control signal indicating that base station-triggered reference signals will be transmitted to the user device. And, operation 220 includes receiving, by the user device, the base station-triggered reference signals on a set of time-frequency resources in at least one physical downlink control channel (PDCCH) search space.

### Example 2

According to an example implementation of example 1, the operation of a user device may further include operation 230 (FIG. 2), including performing signal processing based on the base station-triggered reference signals.

### Example 3

According to an example implementation of any of example 2, the performing signal processing includes performing, by the user device in response to the base station-triggered reference signals, signal processing outside of a time period in which the user device may perform signal processing based on reference signals transmitted with a predefined periodicity.

### Example 4

According to an example implementation of any of examples 1-3, the base station-triggered reference signals include base station-triggered reference signals that are non-periodic (or aperiodic).

### Example 5

According to an example implementation of any of examples 1-4, the control signal is received via downlink control information (DCI) or a MAC (media access control) control element.

### Example 6

According to an example implementation of any of examples 1-5, the control signal indicates one or more time-frequency resources for receiving the reference signals.

### Example 7

According to an example implementation of any of examples 1-6, the control signal includes a bandwidth switching command that indicates a radio frequency (RF or wireless) bandwidth between the base station and the user device is changing.

### Example 8

According to an example implementation of any of examples 1-7, the control signal indicating the base station-triggered reference signals will be transmitted to the user device is included along with at least one of the following control messages received by the user device from the base station: a message indicating a change in bandwidth between the base station and the user device; a message indicating a carrier aggregation configuration, reconfiguration or deactivation; and a message indicating a change in a center frequency for a downlink transmission bandwidth between the base station and the user device.

### Example 9

According to an example implementation of any of examples 1-8, the base station-triggered reference signals include reference signals that are received via at least one of the following: pre-defined time-frequency resources of a physical downlink control channel (PDCCH) common search space (CSS); and pre-defined time-frequency resources of a physical downlink control channel (PDCCH) user device-specific search space (USS) for the user device.

### Example 10

According to an example implementation of any of examples 1-9, the base station-triggered reference signals include base station-triggered demodulation reference signals that are received on predefined time-frequency resources of a physical downlink control channel (PDCCH) common search space (CSS).

### Example 11

According to an example implementation of any of examples 1-10, the base station-triggered reference signals include all pre-defined in a physical downlink control channel (PDCCH) search space in one or more subframes, slots or mini-slots.

### Example 12

According to an example implementation of any of examples 1-11, the base station-triggered reference signals include base station-triggered demodulation reference signals that are received on predefined time-frequency resources of a physical downlink control channel (PDCCH) user device-specific search space (USS) for the user device.

### Example 13

According to an example implementation of any of examples 1-12, the base station-triggered reference signals include reference signals that are received on pre-defined time-frequency resources via two or more antenna ports for a physical downlink control channel (PDCCH) search space.

### Example 14

According to an example implementation of any of examples 1-13, the base station-triggered reference signals include reference signals that are received via one antenna port for a physical downlink control channel (PDCCH) search space for the user device.

### Example 15

According to an example implementation of any of examples 1-14, the receiving a control signal indicating that base station-triggered reference signals will be transmitted to the user device includes receiving a broadcast or group-common message addressed to a plurality of user devices indicating presence of demodulation reference signals on one or more time-frequency resources of a downlink control channel search space (e.g., on time-frequency resources of a downlink control channel common search space (CSS)).

### Example 16

According to an example implementation of any of examples 1-15, the receiving a control signal indicating that base station-triggered reference signals will be transmitted to the user device includes receiving a user device-specific message addressed to a single user device indicating presence of reference signals on one or more time-frequency resources of a downlink control channel search space.

### Example 17

According to an example implementation of any of examples 1-16, the receiving the base station-triggered reference signals includes at least one of the following: receiving reference signals via predetermined time-frequency resources of a downlink control channel common search space (CSS); and receiving reference signals via predetermined time-frequency resources of a downlink control channel user device-specific search space (USS) for the user device.

### Example 18

According to an example implementation of any of examples 1-17, the performing signal processing may include performing at least one of the following based on the base station-triggered reference signals: an automatic gain control (AGC) (which may include monitoring a received signal and controlling a gain automatically in a receiver, such as, e.g., by regulating a received signal strength at the input of ADCs (analog to digital converters) within the UE receiver such that the required signal SNR (signal to noise ratio) for proper decoding is met.); a time synchronization (e.g., determining a start of a frame or symbol); a frequency synchronization; a channel estimation (e.g., estimating or determining a change in amplitude and/or phase for a channel); a channel tracking; and a radio resource management (RRM) measurement (e.g., including measuring one or more of the following: a channel quality indicator (CQI), a reference signal received power (RSRP), a reference signal received quality (RSRQ), and a carrier received signal strength indicator (RSSI)).

### Example 19

According to an example implementation an apparatus includes at least one processor and at least one memory including computer instructions, when executed by the at least one processor, cause the apparatus to: receive, by a user device from a base station, a control signal indicating that base station-triggered reference signals will be transmitted to the user device; receive, by the user device, the base station-triggered reference signals on a set of time-frequency resources in at least one physical downlink control channel (PDCCH) search space; and perform signal processing based on the reference signals.

### Example 20

According to an example implementation, a computer program product includes a non-transitory computer-readable storage medium and storing executable code that, when executed by at least one data processing apparatus, is configured to cause the at least one data processing apparatus to perform a method including: receiving, by a user device from a base station, a control signal indicating that base station-triggered reference signals will be transmitted to the user device; receiving, by the user device, the base station-triggered reference signals on a set of time-frequency resources in at least one physical downlink control channel (PDCCH) search space (e.g., CSS and/or USS); and perform signal processing based on the reference signals.

### Example 21

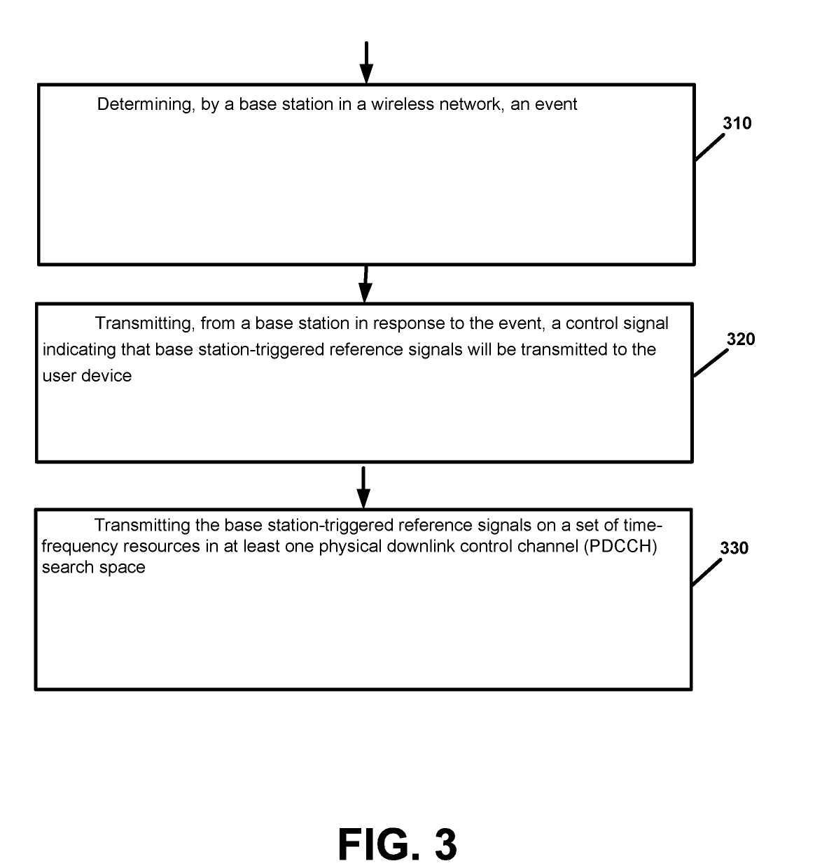

FIG. 3 is a flow chart illustrating operation of a base station according to an example implementation. Operation 310 includes determining, by a base station in a wireless network, an event. Operation 320 includes transmitting, from a base station in response to the event, a control signal indicating that base station-triggered reference signals will be transmitted to the user device. And, operation 330 includes transmitting the base station-triggered reference signals on a set of time-frequency resources in at least one physical downlink control channel search space.

### Example 22

According to an example implementation of example 21, determining the event includes: determining that a change in bandwidth between the base station and the user device will be performed by the base station; and wherein the transmitting the control signal includes transmitting a bandwidth switching command that indicates a RF (radio frequency or wireless) bandwidth between the base station and the user device is changing.

### Example 23

According to an example implementation of any of examples 1-22, the reference signals include demodulation reference signals.

### Example 24

According to an example implementation of any of examples 1-23, the control signal is transmitted via downlink control information (DCI) or via a MAC (media access control) control element.

### Example 25

According to an example implementation of any of examples 1-24, the control signal indicates one or more time-frequency resources for transmitting the base station-triggered reference signals.

### Example 26

According to an example implementation of any of examples 1-25, the control signal indicating the base station-triggered reference signals will be transmitted to the user device is included along with at least one of the following control messages transmitted by the base station: a message indicating a change in bandwidth between the base station and the user device; a message indicating a carrier aggregation configuration, reconfiguration or deactivation; and a message indicating a change in a center frequency for a downlink transmission bandwidth between the base station and the user device.

### Example 27

According to an example implementation of any of examples 1-26, the base station-triggered reference signals (e.g., which may include base station-triggered demodulation reference signals) are transmitted via at least one of the following: pre-defined time-frequency resources of a physical downlink control channel (PDCCH) common search space (CSS); and pre-defined time-frequency resources of a physical downlink control channel (PDCCH) user device-specific search space (USS) for the user device.

### Example 28

According to an example implementation of any of examples 1-27, the base station-triggered reference signals include base station-triggered reference signals that are transmitted on predefined time-frequency resources of a physical downlink control channel (PDCCH) common search space (CSS).

### Example 29

According to an example implementation of any of examples 1-28, the base station-triggered reference signals include base station-triggered reference signals that are transmitted on predefined time-frequency resources of a physical downlink control channel (PDCCH) user device-specific search space (USS) for the user device.

### Example 30

According to an example implementation of any of examples 1-29, the base station-triggered reference signals include base station-triggered reference signals that are transmitted via two antenna ports, e.g., via two reference signal antenna ports for a physical downlink control channel (PDCCH) common search space (CSS).

### Example 31

According to an example implementation of any of examples 1-29, the base station-triggered reference signals include base station-triggered reference signals that are transmitted via one antenna port, e.g., via one reference signal antenna port for a physical downlink control channel (PDCCH) user device-specific search space (USS) for the user device.

### Example 32

According to an example implementation of any of examples 1-31, the transmitting a control signal indicating that base station-triggered reference signals will be transmitted to the user device includes transmitting a broadcast or group-common message addressed to a plurality of user devices indicating a presence of base station-triggered reference signals on one or more time-frequency resources of a downlink control channel search space (such as a PDCCH common search space (CSS)).

### Example 33

According to an example implementation of any of examples 1-32, the transmitting a control signal indicating that base station-triggered reference signals will be transmitted to the user device includes transmitting a user device-specific message addressed to a single user device indicating a presence of reference signals on one or more time frequency resources of a downlink control channel search space (e.g., on one or more resources of a PDCCH user device-specific search space (USS)).

### Example 34

According to an example implementation, an apparatus includes at least one processor and at least one memory including computer instructions, when executed by the at least one processor, cause the apparatus to: determine, by a base station in a wireless network, an event; transmit, from a base station in response to the event, a control signal indicating that base station-triggered reference signals will be transmitted to the user device; and, transmit the base station-triggered reference signals on a set of time-frequency resources in at least one physical downlink control channel (PDCCH) search space.

### Example 35

According to an example implementation, an apparatus includes means for performing any of the operations or method steps of any of examples 1-33.

A number of example implementations and/or further illustrative example details will be described.

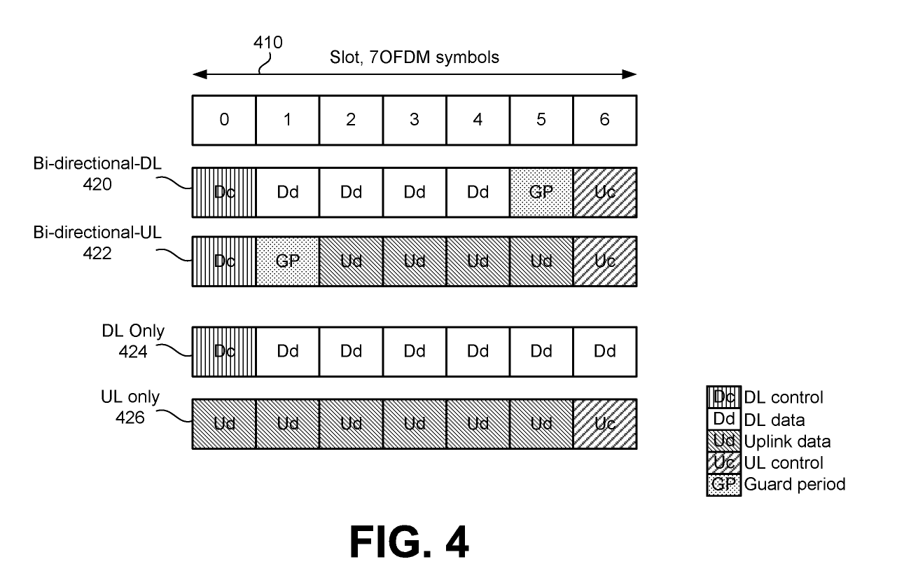

FIG. 4 is a diagram illustrating different slot types according to an example implementation. In an example implementation, a slot 410 (e.g., time slot which may be a regular scheduling unit) may include 7 OFDM (orthogonal frequency division multiplexing) symbols, e.g., including symbols 0-6, and a mini-slot may include a scheduling unit shorter than a slot, e.g. 1-3 OFDM symbols. There are three slot types shown in FIG. 4, including, e.g., bidirectional (that includes both uplink and downlink information) slot types, downlink (DL) only (that includes only DL information) slot types, and uplink (UL) only (that includes only UL information) slot types. Bidirectional DL slot 420 includes downlink control (Dc) and downlink data (Dd), and uplink control (Uc), and thus includes only DL data. Bidirectional UL slot 422 includes downlink control (Dc) and uplink data (Ud), and uplink control (Uc), and thus includes only UL data (no DL data). A DL only slot 424 includes downlink control (Dc) and downlink data (Dd), while an UL only slot 426 includes uplink data (Ud) and uplink control (Uc). Thus, for bidirectional slots, there is either downlink data or uplink data transmission in each slot, as well as the corresponding downlink and uplink control. In some cases, the bi-directional slot may facilitate one or more TDD (time division duplex) functionalities, such as, for example: link direction switching between DL and UL; fully flexible traffic adaptation between DL and UL; and, opportunity for low latency, provided that slot length is selected to be short enough, for example.

In all (or at least some of the) slots, multiplexing between DL control, DL/UL data, GP (guard period between downlink and uplink transmissions) and UL control is based primarily on time division multiplexing allowing fast energy efficient pipeline processing of control and data in the receiver. According to an example implementation, Physical Downlink Control Channel (PDCCH) may be conveyed in the DL control symbol(s) located at the beginning of the slot (or mini-slot).

In addition to bi-directional slots 420, 422, there are also DL only slot 424 and UL only slot 426 in FIG. 4. The slots 424 and 426 may be used, for example, at least in FDD (frequency division duplex) mode, but also in certain TDD (time division duplex) scenarios to allow longer transmission periods in same direction.

As noted above, each PDCCH may be transmitted using one or more control channel elements (CCE). Different PDCCH sizes with different CCE aggregation levels (e.g., including 1, 2, 4 or 8 CCEs) may be used, as illustrative examples. As also noted above, there may be two different types of search spaces, including common search space (CSS) and user device-specific search space (USS).

While some type of systems may transmit non-precoded common reference signals (CRS) every subframe, this type of transmission may create significant reference signal overhead, increase interference, and/or prevent a BS from obtaining some energy savings. Thus, according to an example implementation, some type of references signals (e.g., DMRS signals), rather than being transmitted continuous or periodically (e.g., every subframe or slot), these type of references signals (e.g., reference signals, or DMRS, which may be precoded for a specific UE, or non-precoded) are transmitted based on a BS detecting an occurrence of a specific event or based on the BS determining that a UE(s) will need such reference signals (e.g., DMRS signals). Thus, to provide a leaner design, e.g., in which there is less reference signal overhead, less reference signal interference, and more opportunities for BS energy savings, a type of reference signals are transmitted when triggered (or transmission caused by) in response the BS detecting an event or need by a UE for such reference signals. Thus, the BS-triggered reference signals may be aperiodic and may include a type of reference signals that are triggered or caused to be transmitted based on the BS detecting an occurrence of an event or condition. The event or condition (which will trigger transmission of the reference signals, such as DMRS signals) may include any event or condition, such as, for example, determining or detecting by the BS that a RF band switch will occur/has occurred for the user device/UE, which means that the UE will have a need to receive such DMRS signals to perform signal processing, such as synchronization, update AGC, etc., for the new RF bandwidth/transmission bandwidth. It is possible that a different type of (or other) reference signals may still be transmitted continuously or periodically, e.g., every slot, every subframe, every frame when data related to corresponding RS/DMRS is present. In addition, according to another example implementation, some reference signals may be BS-triggered (or transmitted by BS in response to a triggering event that is independent from the presence of data for transmission to the UE), and other reference signals may be transmitted in a non-triggered manner (e.g., where such reference signals may be transmitted periodically, without regard to detection of events).

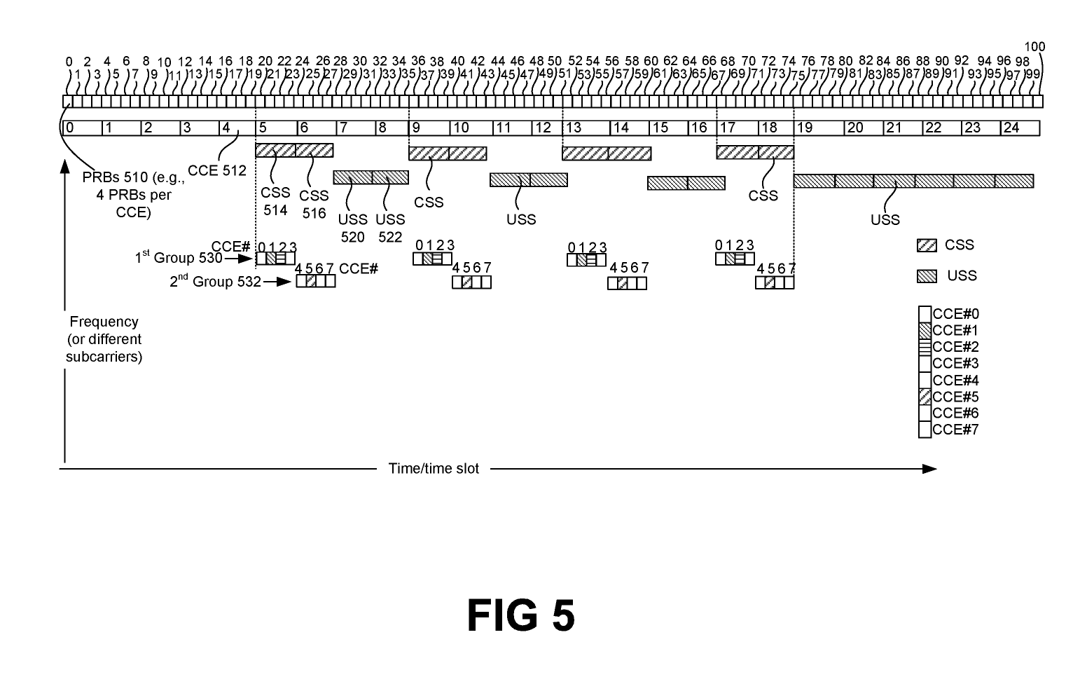

FIG. 5 is a diagram illustrating control channel (e.g., PDCCH) search spaces for common search space (CSS) and user device-specific search space (USS) according to an illustrative example implementation. The CSS and USS, which may include the reference signals (e.g., DMRS signals) supporting coherent detection of PDCCH can be arranged in the frequency domain in a flexible manner, for example: BS may configure both CSS and USS in a flexible manner in frequency; CSS may, for example, always be located in the first OFDM symbol of the slot of the CSS (or in the case of narrowband operation requiring a high number of CCEs, such as 8, CSS may be located within first two OFDM symbols of the slot); USS may have more flexibility in time. For example, it may cover one or more OFDM symbols at the beginning of the slot, or it may be located in the first symbol of a mini-slot (e.g., which may be e.g. 1-3 symbols, which is smaller/shorter than a slot). USS and CSS configuration may be done according to a 4-PRB raster in which a CCE size (control channel element) used is 4 PRBs (a 4 PRB CCE for USS or CSS, in this illustrative example). For example, a CCE size may be 4 PRBs (PRBs 510, FIG. 5) in one OFDM symbol (OFDM symbols 512, FIG. 5). Both localized CCE and distributed CCEs may be supported for the CSS and USS. For example, a localized CCE consists of four consecutive PRBs within a 4-PRB raster. For example, by a 4-PRB raster, this means that CCE/CCE group (consisting of 4 PRBs in this example) starting positions are limited according to the raster (i.e., every fourth PRB are supported in the current example: 0, 4, 8. In the exemplary figure below, USS follows localized CCE allocation.

Resource elements (REs), e.g., PRBs for each CCE may be localized (e.g., PRBs of a CCE provided on frequency resources of one frequency/subcarrier), or distributed (e.g., distributed or spread across multiple frequency resources to improve frequency diversity). As shown in the illustrative example of FIG. 5, four physical resources blocks (PRBs) 510 may be provided for each CCE 512. CCEs are shown for both CSS and USS. According to an example implementation, in the case of localized allocation, four consecutive PRBs in the grid are allocated to a single CCE. In the case of distributed allocation, four PRBs are distributed in frequency according to a four PRB raster.

As shown in FIG. 5, frequency diversity may be provided by CSS, including a first group 530 of four PRBs at a first frequency or first set of frequencies and from different CCEs provided for CSS 514; and a second group 532 of four PRBs at a (set of) second frequencies and from different CCEs provided for CSS 516. In the current example, two groups cover altogether 8 CCEs and 32 PRBS.

Thus, as shown in FIG. 5, distributed PRBs may, for example, be allocated in 4-CCE groups (e.g., including group 530 and group 532). CSS follows distributed CCE allocation, e.g., according to example shown in FIG. 5, e.g., where 1 CCE (e.g., CCE #0) includes 4 PRBs (physical resource blocks 510).

Thus, according to an example implementation, a lean carrier design, e.g., which may include a scarce RS/DMRS for improved BS energy savings and reduce signal interference is provided. According to an example implementation, when a triggering event occurs (or is detected by the BS), such as a RF band switching for a user device (e.g., where the transmission bandwidth is increased or decreased), the BS may send a control signal (e.g., within the DCI sent to the user device, within a control element, or other control signal sent to the user device) to the user device that indicates that a (BS-triggered) RS or DMRS signal will be transmitted to the user device. For example, a RF bandwidth change control signal may be sent by the BS to the user device to indicate that the RF bandwidth for the user device is changing, which may also serve as an indication that reference signals will be sent via predefined resources (e.g., via first one, or first two OFDM symbols of next 3 consecutive slots, for example), e.g., to allow the user device to perform synchronization, AGC update, and channel estimation via the triggered reference signals, for example. For example, the reference signals (RSs) may be sent via predefined resources within CSS (e.g., DMRS sent via first symbol or first 2 symbols of next X number of slots of CSS) or within indicated time-frequency resources, or within a time-frequency resource (either predefined time or time-frequency resource, or an explicitly indicated time-frequency resource) of USS for the user device.

According to an example implementation, when PDCCH is transmitted via CSS contains DCI for at least one UE, RS or DMRS may typically be present at least in PDCCH CSS, at least in CCE(s) with DCI. Additionally the RS or DMRS may also be present in a number of symbols and/or slots (i.e., within some time period) prior to the PDCCH CSS transmission. However, when there is no DCI in certain slot (or mini-slot), it may be up-to BS to define whether or not to transmit RS or DMRS via corresponding resource elements of PDCCH CCEs, e.g., a BS-triggered RS/DMRS. Transmitting BS-triggered RS/DMRS via PDCCH CCEs may assist in helping UEs to maintain synchronization. Transmitting RS/DMRS less often would correspond to a lean (or leaner) carrier operation enabling energy saving for BS and would reduce the reference signal overhead, but may reduce the synchronization and AGC opportunities for UEs. Hence, it may be desirable to allow BS to detect an event, and then transmit BS-triggered RS/DMRS signals, e.g., as needed by the UEs (e.g., as determined by the BS). Thus, for example, a BS may transmit a RS/DMRS and DCI to each of UE1 and UE2 via CSS (non-precoded RS/DMRS). If no RF bandwidth switching is performed for UE1, then no additional RS/DMRS is triggered and sent to UE1. If RF bandwidth switching is performed for UE2, then BS triggers the transmission of BS-triggered DMRS signals to UE2, e.g., in addition to any other RS/DMRS signals that may be sent to UE1 and UE2.

According to an example implementation, RS or DMRS of PDCCH CSS may be used as a signal to assist UE's with frequency/time synchronization as well as AGC setting (and possibly for other possible use cases such as radio resource measurement (RRM) measurements as well). The BS may indicate the presence of RS or DMRS in PDCCH CSS to the UE, e.g., via control signal provided in DCI (e.g., RF bandwidth switching command to UE), via control element or other control signal sent to UE. The UE is then aware of those slots (or mini-slots) where PDCCH DMRS on CSS is present and can use it for signal processing (such as synchronization and AGC). The control signal indicating triggered RS or DMRS signals may be combined with, or sent with some other signal, such as signal triggering (dynamic) bandwidth adaptation, carrier aggregation (re-)configuration/(de-)activation, change in center frequency or other control signal sent by BS to UE. When the center frequency and/or bandwidth for UE transmission/reception is changed, the PDCCH CSS that carries the BS-triggered RS may correspond to the CSS defined for the frequency band after the change, which may differ from the CSS defined for the frequency band before the change.

When UE receives the indication (the control signal indicating transmission of BS-triggered RS/DMRS signals), this indicates to the UE that at least PDCCH DMRS is available in the CSS (e.g., within specific resources, such as within first symbol of next X number (e.g., next 3) of contiguous slots (or subframes), such as within first symbol of next three slots). The exact locations may be configured via higher layer signaling. In some scenarios, there can be also more than one configuration available for different scenarios/use cases. BS may select one configuration out of N available configurations and convey the information of the selected configuration to the UE, e.g., as part of RS/DMRS triggering.

The triggering of the sending the RS/DMRS indication and the transmission of the BS-triggered RS/DMRS signals may involve a set of predetermined or predefined rules, which may be determined by specification and/or configured by higher layer signaling. For example, a configuration may indicate specific time slots or mini-slots, in which PDCCH CSS contains RS/DMRS. In the case of TDD, triggering may relate to certain predetermined DL slots/symbols.

In addition to PDCCH CSS, RS/DMRS may be sent via PDCCH USS. According to an example implementation, only predetermined or preconfigured CCEs in the USS may be used for synchronization purposes, as an illustrative example. Assuming that USS utilizes rank1 (one layer) precoding for PDCCH, there would be one RS/DMRS port (logical antenna port) available for signal assisting synchronization (assuming that PDCCH supports up to two antenna ports for RS/DMRS, due to open-loop diversity transmission). The advantage of this approach is that USS can be more easily extended in time to cover not only the first symbol of the slot (such as CSS), but also the second control symbol of the slot as well as mini-slots (provided that mini-slot does not contain CSS). This would provide faster synchronization and smaller synchronization error.

In one example scenario, a UE may use only the second RS/DMRS antenna port of USS to transmit BS-triggered RS/DMRS for synchronization and AGC. UE may assume that this antenna port is non-precoded, for example.

In another example scenario UE utilizes (also) the first RS/DMRS antenna port of USS for synchronization (for BS-triggered RS/DMRS signals). The first RS/DMRS antenna port, including the RS/DMRS signal, may be precoded (for user device) similarly as PDCCH data (if that is present).

In yet another example scenario, UE utilizes two-port non-precoded RS/DMRS also in the predetermined CCEs of USS used for BS-triggered RS/DMRS signal. In this case, PDCCH may apply transmission diversity instead of rank1 precoding.

In one embodiment, the BS may reserve, e.g., one RS/DMRS antenna port for aforementioned synchronization purposes (for BS-triggered RS/DMRS signal), e.g. every nth slot in frequency domain the CSS region is spanned upon. Furthermore, the BS may indicate to the UE via CSS about the non-precoded data RS/DMRS (PDSCH DMRS) port(s) so that UE would be aware of non-precoded ports in time and frequency domain. Indication may be part of the above mentioned triggers. For instance, one OFDM symbol (assuming front-loaded RS/DMRS) may contain REs (resource elements) for 8 or even 16 RS/DMRS antenna ports. Thus, BS may reserve, e.g., one of these RS/DMRS antenna ports occasionally, e.g. when associated to above triggering mechanisms, for synchronization purposes.

In another example scenario or implementation, BS may transmit a broadcast or group-common message to a group (e.g., plurality of UEs) to indicate the presence of RS/DMRS in certain time-frequency resources (e.g. corresponding to the CSS of one or more UEs). This use of a group message or broadcast message to indicate (non-precoded) BS-triggered RS/DMRS may have the following advantages: Multiple UEs can use the RS/DMRS for synchronization, AGC updated, and other purposes; and, if some of the PRBs are not used by PDCCH (other than transmitting RS/DMRS) and are reused for data transmissions, the indication would allow the proper rate matching (or puncturing) of PDSCH around the RS/DMRS REs, for example.

In yet another example scenario or implementation, reference signals (e.g., DMRS) may have different bandwidths (BWs) between CSS and USS. For example, USS reference signals (e.g., USS DMRS signals) may occupy the same bandwidth as DCI, whereas CSS reference signals (e.g., CSS DMRS signals) may occupy a larger bandwidth than DCI. As shown in the example of FIG. 5, CSS may include groups of consecutive PRBs. One DCI may occupy only part of PRBs within one group whereas the reference signals (DMRS) may be transmitted over the whole group (see first and second groups, 530, 532). This principle can be extended also to a USS scenario having different reference signal (DMRS signal) allocation principle for distributed and localized CCEs. Assuming that non-precoded reference signal (DMRS signal) is used within the CCE group with distributed allocation (in USS), DCI may occupy only part of PRBs within one group whereas reference signal (e.g., DMRS signal) is transmitted over the whole group. In this embodiment, the UE can improve channel estimation by performing filtering over the group of PRBs, for example.

Although some example implementations are described with reference to BS-triggered DMRS in PDCCH CSS/USS, other example implementations may be provided for BS-triggering of other types of reference signals. According to an example implementation, one or more features may include, for example, use of a dynamic signaling (e.g., BS-triggered transmission of control signal or DMRS indication, such as RF bandwidth switching command), in addition to a lean carrier design, to inform the UE(s) that reference signals (e.g., DMRS) will be transmitted and to possibly indicate in which time-frequency resources the RS (e.g., DMRS) is transmitted (alternatively, rather than indicating or signaling resources for transmission of reference signals, default or predefined time-frequency resources in USS or CSS may be used to transmit reference signals or DMRS); dynamic signaling (e.g., DMRS indication, such as RF bandwidth change command) can be conveyed, e.g., in the form of DCI or MAC CE (MAC control element) or other control signal that is transmitted from BS to UE. For example, the triggering of the transmission of the DMRS indication and transmission of the BS-triggered reference signal (e.g., DMRS) may include, for example, any scenario where RF bandwidth and/or center frequency changes (e.g., in dynamic manner), as illustrative example triggering conditions. Other triggering conditions may also be used to cause the BS to notify the UE (of the upcoming transmission of the DMRS signals) and then to transmit the BS-triggered DMRS signals.

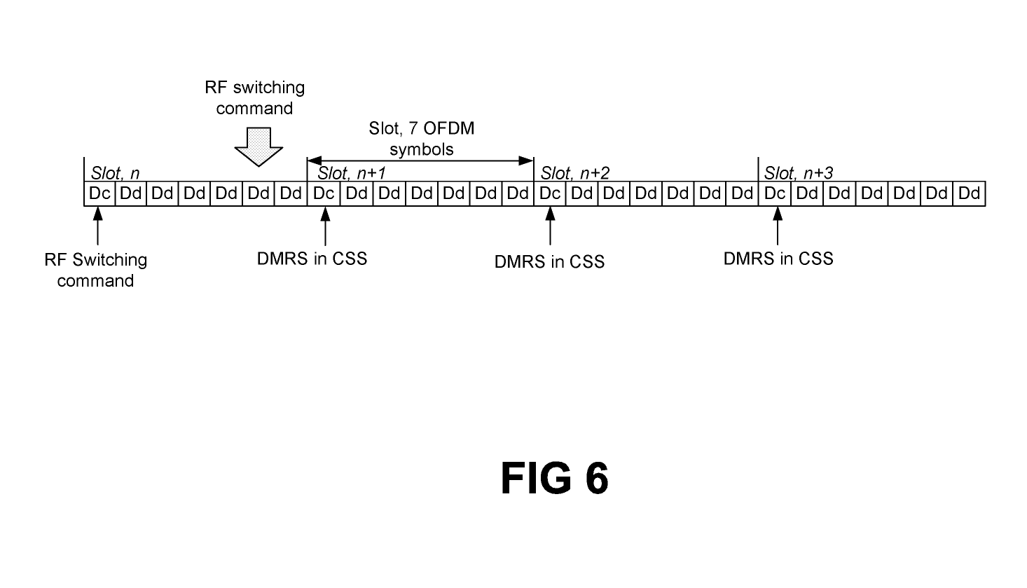

FIG. 6 is a diagram illustrating a transmission of a RF bandwidth switching command during slot n, and transmission of BS-triggered reference signals (which may be DMRSs) during slots n+1, n+2, and n+3 according to an example implementation. As shown in FIG. 6, the RF bandwidth switching command is sent by the BS to the UE within the DCI (first symbol that includes downlink control information, Dc) in slot n. Subsequently, the BS-triggered RS or DMRS signals are transmitted via predefined time-frequency resources of the CSS, such as, for example, via the first symbol (indicated by Dc, meaning downlink control information) of slots n+1, n+2, and n+3, in this illustrative example. Also, in this illustrative example shown in FIG. 6, the UE performs RF bandwidth switching during slot n; UE knows that slots n+1, n+2 and n+3 contain RS/DMRS in PDCCH CSS (e.g., within symbol 1 of these slots); and; that BS-triggered RS/DMRS signal (received via CSS in slots n+1, n+2 and n+3) is available for the UE to perform AGC, frequency+time synchronization, channel estimation, etc. The UE would be ready to receive/transmit according to new RF configuration (new RF bandwidth) in slot n+4. Alternatively, the UE may also be able to receive/transmit before slot n+4 but with possibly degraded performance due to time/frequency synchronization errors (e.g., due to time/frequency synchronization at UE being inaccurate or not being completed based on new RF bandwidth).

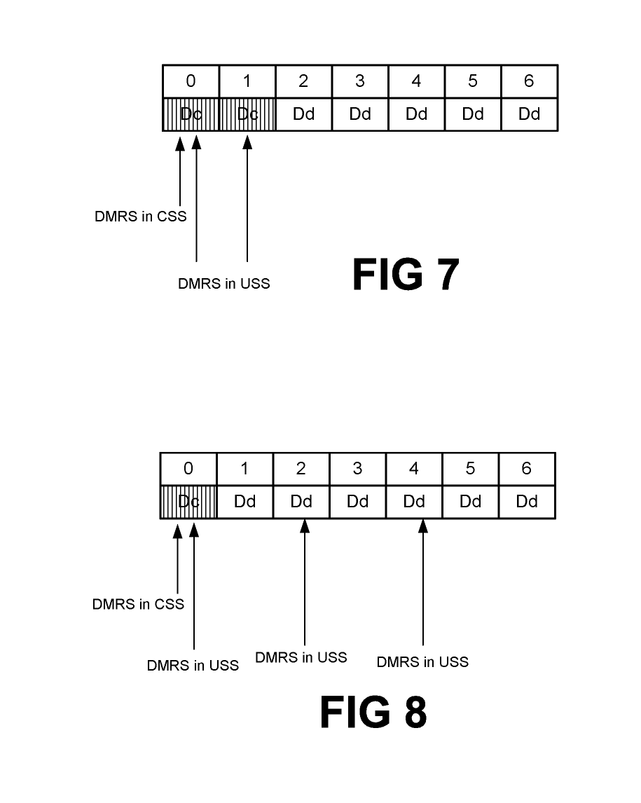

FIG. 7 is a diagram illustrating a slot-based transmission of reference signal (RS) in CSS and USS according to an example implementation. As shown, the RS (e.g., which may be DMRS) may be transmitted in CSS via first symbol (symbol 0, indicated as Dc), while RS/DMRS may also be transmitted via USS via first and second symbols (symbols 0, 1).

FIG. 8 is a diagram illustrating a mini-slot-based transmission of reference signal (e.g., DMRS) in CSS and USS according to an example implementation. As shown for the mini-slot based transmission of RS/DMRS, the RS/DMRS may be transmitted in CSS via first symbol (symbol 0, indicated as Dc), while RS/DMRS may also be transmitted in USS via symbols 0, 2 and 4, for example. These are merely some illustrative examples, and others may be provided.

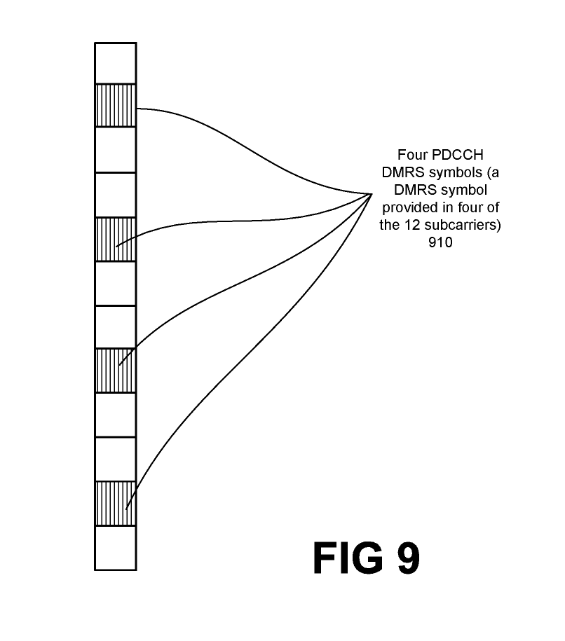

FIG. 9 is a diagram illustrating an exemplary reference signal (e.g., DMRS) structure for PDCCH (applicable to both CSS and USS). This RS/DMRS structure covers, for example, 12 sub-carriers, and four of the subcarriers (910) are allocated to PDCCH DMRS. For example, there may be two orthogonal DMRS ports are created for each DMRS symbol. These DMRS ports (e.g., where each DMRS port may correspond to two orthogonal DMRS layers within PRB) may be created by means of CDM (code division multiplexing) and/or FDM (frequency division multiplexing). For example, in the case of PDCCH CSS, two antenna ports may be non-precoded. In the case of PDCCH USS, DMRS can be precoded similarly as PDCCH data according to rank1. In an example implementation, the second antenna port in CSS may be used for assisting AGC/synchronization and may be non-precoded, for example.

According to an example implementation, RS or DMRS (demodulation reference signals) of PDCCH (physical downlink control channel) CSS (common search space) is a signal that can be used as a signal assisting UE's frequency/time synchronization as well as AGC setting (and possibly for other possible use cases such as RRC (radio resource control or radio resource measurements) measurements as well), e.g., when UE RF bandwidth changes. A time/frequency resource containing at least one search space may be obtained by UE from MIB (management information block)/system information and/or implicitly derived from initial access information.

According to an example implementation, when PDCCH transmitted via CSS contains DCI (downlink control information) for at least one UE, RS or DMRS will always (or at least typically) be present at least in NR-CCEs (new radio/5G control channel elements or resource elements) carrying DCI. However, when there is no DCI in certain slot(s), it may be up-to gNB (e.g., 5G BS) to define whether or not to transmit RS or DMRS via corresponding resource elements of PDCCH CCEs. Thus, BS-triggered RS or DMRS may occur when a BS detects one or more events, e.g., where it may be useful in such cases to transmit RS/DMRS to UEs. An example of such an event that may trigger a BS to transmit RS/DMRS may be a change in RF bandwidth for the UE. Transmitting RS/DMRS via PDCCH CCEs may assist UEs to maintain synchronization, to perform updated AGC, allow for updated coherent demodulation, etc., based on new DMRS signals. Also, such on-demand or BS-triggered RS/DMRS transmission may allow the BS to provide a lean carrier design, e.g., by decreasing or possibly turning off the transmission of some reference signals, such as to at least decrease the always-on or RS/DMRS signals transmitted, e.g., every subframe or slot, for example, thereby improving BS energy savings and reducing reference signal interference. Not transmitting RS/DMRS would correspond to lean carrier operation enabling energy saving for gNB, and it also reduce the RS overhead. Providing BS-triggered RS/DMRS may still allow the UE to perform updated signal processing, such as updated AGC, maintain synchronization, perform updated channel estimation for coherent demodulation, etc.

In order to facilitate complementary synchronization signal at UE in an implementation friendly manner, gNB (5G BS) may, for example, transmit RS or DMRS in PDCCH CSS and indicate this to the UE (e.g., by sending a control signal to UE indicating the transmission of BS-triggered DMRS). The UE becomes then aware the time instants (slots), e.g., such as first symbol of next three slots, where PDCCH DMRS on CSS is present and the UE can use this BS-triggered DMRS for signal processing (such as synchronization and AGC). Thus, BS-triggered RS/DMRS in PDCCH CSS can be used as a signal assisting UE's frequency/time synchronization. The BS-triggered RS/DMRS in the PDCCH CSS may provide a way to provide complimentary synchronization signal, e.g., in the case of RF bandwidth configuration changes for UE.

Further illustrative example implementations are now described, by way of illustrative example. According to an example implementation, a common search space (CSS) may be useful, e.g., to convey DL control information (DCI) (such as DL/UL grants) for UEs, which don't yet have UE-specific search space (USS) configured. The CSS may be located in the first OFDM symbol of the slot. CSS mapping may be, for example, based on the following assumptions: The size of NR (5G new radio)-CCE (control channel element or resource element) is 4 PRBs (physical resource blocks). NR-CCEs are mapped into a 4-PRB raster. This provides smooth multiplexing between NR-CCEs covering both USS and CSS. Common search space may include or consist of NR-CCEs, each having four PRBs mapped in a distributed manner in the frequency domain. This approach may allow to maximize, or at least improve, the frequency diversity within each NR-CCE (5G new radio control channel element). NR-CCEs in the common search space may, for example, be allocated in 4-CCE groups, for example.

In at least some of the scenarios, it may be enough to map the CSS always in the first OFDM symbol of the slot. However, if the UE bandwidth capability is strictly limited (e.g. 5 MHz with 15 kHz subcarrier spacing) and there is a need to support up-to 8 NR-CCEs, NR-CCEs corresponding to CSS may need to be mapped into multiple (two) OFDM symbols, for example.

According to an example implementation, time/frequency resources containing additional search spaces (USS), can be configured using dedicated RRC signaling. For example, the following assumptions may be made, by way of example: The size of NR-CCE is 4 PRBs. NR-CCEs are mapped into a 4-PRB raster. Four NR-CCEs (#0-#3) are mapped in localized manner in frequency. Localized mapping benefits from the frequency domain scheduling gain when gNB is aware of the channel state information. Four NR-CCEs (#4-#7) are mapped based on to distributed allocation, which allows to maximize or at least improve frequency diversity within each NR-CCE.

In addition, according to an example implementation, NR (5G new radio) may provide or include a control channel candidate to be mapped to multiple OFDM symbols, or to a single OFDM symbol. It should be possible to have at least certain NR-CCEs of USS overlapping with CSS.

### Example #1

The size of NR-CCE is 4 PRBs.

### Example #2

NR-CCEs are mapped to a 4-PRB raster.

### Example #3

Common search space consists of NR-CCEs with PRBs distributed in the frequency. NR-CCEs in CSS are allocated in 4-CCE groups.

### Example #4

gNB (5G BS) configurability for CSS includes at least CSS location in frequency and CSS bandwidth.

### Example #5

User specific search space supports both localized and distributed mapping of PRBs in frequency.

### Example #6

Distributed mapping of PRBs is common for both CSS and USS.

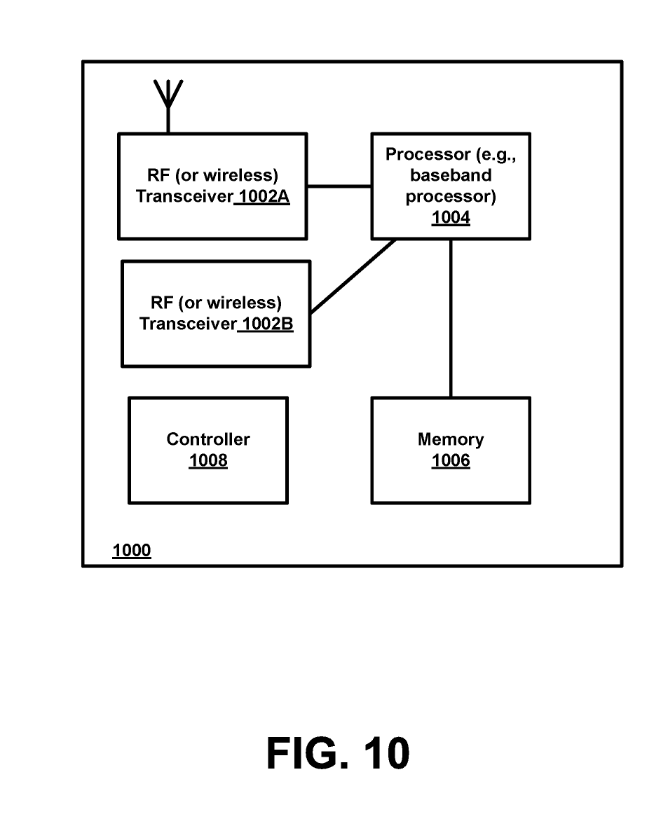

FIG. 10 is a block diagram of a wireless station (e.g., AP, BS, eNB (macro or micro), UE or user device) 1000 according to an example implementation. The wireless station 1000 may include, for example, one or two RF (radio frequency) or wireless transceivers 1002A, 1002B, where each wireless transceiver includes a transmitter to transmit signals and a receiver to receive signals. The wireless station also includes a processor or control unit/entity (controller) 1004 to execute instructions or software and control transmission and receptions of signals, and a memory 1006 to store data and/or instructions.

Processor 1004 may also make decisions or determinations, generate frames, packets or messages for transmission, decode received frames or messages for further processing, and other tasks or functions described herein. Processor 1004, which may be a baseband processor, for example, may generate messages, packets, frames or other signals for transmission via wireless transceiver 1002 (1002A or 1002B). Processor 1004 may control transmission of signals or messages over a wireless network, and may control the reception of signals or messages, etc., via a wireless network (e.g., after being down-converted by wireless transceiver 1002, for example). Processor 1004 may be programmable and capable of executing software or other instructions stored in memory or on other computer media to perform the various tasks and functions described above, such as one or more of the tasks or methods described above. Processor 1004 may be (or may include), for example, hardware, programmable logic, a programmable processor that executes software or firmware, and/or any combination of these. Using other terminology, processor 1004 and transceiver 1002 together may be considered as a wireless transmitter/receiver system, for example.

In addition, referring to FIG. 10, a controller (or processor) 1008 may execute software and instructions, and may provide overall control for the station 1000, and may provide control for other systems not shown in FIG. 10, such as controlling input/output devices (e.g., display, keypad), and/or may execute software for one or more applications that may be provided on wireless station 1000, such as, for example, an email program, audio/video applications, a word processor, a Voice over IP application, or other application or software.

In addition, a storage medium may be provided that includes stored instructions, which when executed by a controller or processor may result in the processor 1004, or other controller or processor, performing one or more of the functions or tasks described above.

According to another example implementation, RF or wireless transceiver(s) 1002A/1002B may receive signals or data and/or transmit or send signals or data. Processor 1004 (and possibly transceivers 1002A/1002B) may control the RF or wireless transceiver 1002A or 1002B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Implementations may also be provided on a computer readable medium or computer readable storage medium, which may be a non-transitory medium. Implementations of the various techniques may also include implementations provided via transitory signals or media, and/or programs and/or software implementations that are downloadable via the Internet or other network(s), either wired networks and/or wireless networks. In addition, implementations may be provided via machine type communications (MTC), and also via an Internet of Things (JOT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, implementations of the various techniques described herein may use a cyber-physical system (CPS) (a system of collaborating computational elements controlling physical entities). CPS may enable the implementation and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various implementations of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving, by a user device from a base station, a control signal indicating that base station-triggered reference signals will be transmitted to the user device; and
receiving, by the user device, the base station-triggered reference signals on a set of time-frequency resources in at least one physical downlink control channel (PDCCH) search space.

2. The method of claim 1 and further comprising:
performing signal processing based on the base station-triggered reference signals.

3. The method of claim 2, wherein the performing signal processing comprises:
performing, by the user device in response to the base station-triggered reference signals, signal processing outside of a time period in which the user device may perform signal processing based on reference signals transmitted with a predefined periodicity.

4. The method of claim 1 wherein the base station-triggered reference signals comprise reference signals that are non-periodic.

5. The method of claim 1 wherein the control signal is received via downlink control information (DCI) or a MAC (media access control) control element.

6. The method of claim 1 wherein the control signal indicates one or more time-frequency resources for receiving the reference signals.

7. The method of claim 1 wherein the control signal comprises a bandwidth switching command that indicates a RF bandwidth between the base station and the user device is changing.

8. The method of claim 1 wherein the control signal indicating the base station-triggered reference signals will be transmitted to the user device is included along with at least one of the following control messages received by the user device from the base station:
a message indicating a change in bandwidth between the base station and the user device;
a message indicating a carrier aggregation configuration, reconfiguration or deactivation; and
a message indicating a change in a center frequency for a downlink transmission bandwidth between the base station and the user device.

9. The method of claim 1 wherein the base station-triggered reference signals comprise reference signals that are received via at least one of the following:
pre-defined time-frequency resources of a physical downlink control channel (PDCCH) common search space (CSS); and
pre-defined time-frequency resources of a physical downlink control channel (PDCCH) user device-specific search space (USS) for the user device.

10. The method of claim 1 wherein the base station-triggered reference signals comprise base station-triggered demodulation reference signals that are received on predefined time-frequency resources of a physical downlink control channel (PDCCH) common search space (CSS).

11. The method of claim 1 wherein the base station-triggered reference signals comprise all pre-defined reference signals in a physical downlink control channel (PDCCH) search space in one or more subframes, slots or mini-slots.

12. The method of claim 1 wherein the base station-triggered reference signals comprise base station-triggered demodulation reference signals that are received on predefined time-frequency resources of a physical downlink control channel (PDCCH) user device-specific search space (USS) for the user device.

13. The method of claim 1 wherein the base station-triggered reference signals comprise reference signals that are received on predefined time-frequency resources via two or more antenna ports for a physical downlink control channel (PDCCH) search space.

14. The method of claim 1 wherein the base station-triggered reference signals comprise reference signals that are received on predefined time-frequency resources via one antenna port for a physical downlink control channel (PDCCH) search space for the user device.

15. The method of claim 1 wherein the receiving a control signal indicating that base station-triggered reference signals will be transmitted to the user device comprises receiving a broadcast or group-common message addressed to a plurality of user devices indicating presence of demodulation reference signals on one or more time-frequency resources of a downlink control channel search space.

16. The method of claim 1 wherein the receiving a control signal indicating that base station-triggered reference signals will be transmitted to the user device comprises receiving a user device specific message addressed to a single user device indicating presence of reference signals on one or more time-frequency resources of a downlink control channel search space.

17. The method of claim 1 wherein the receiving the base station-triggered reference signals comprises at least one of the following:
receiving reference signals via predetermined time-frequency resources of a downlink control channel common search space (CSS); and
receiving reference signals via predetermined time-frequency resources of a downlink control channel user device-specific search space (USS) for the user device.

18. The method of claim 2 wherein the performing signal processing comprises performing at least one of the following based on the base station-triggered reference signals:
an automatic gain control (AGC);
a time synchronization;
a frequency synchronization;
a channel estimation;
a channel tracking; and
a radio resource management (RRM) measurement, including measuring one or more of the following: a channel quality indicator (CQI), a reference signal received power (RSRP), a reference signal received quality (RSRQ), and a carrier received signal strength indicator (RSSI).

19. An apparatus comprising at least one processor and at least one memory including computer instructions, when executed by the at least one processor, cause the apparatus to:
receive, by a user device from a base station, a control signal indicating that base station-triggered reference signals will be transmitted to the user device;
receive, by the user device, the base station-triggered reference signals on a set of time-frequency resources in at least one physical downlink control channel (PDCCH) search space;
perform signal processing based on the reference signals.

20. A computer program product comprising a non-transitory computer-readable storage medium and storing executable code that, when executed by at least one data processing apparatus, is configured to cause the at least one data processing apparatus to perform a method comprising:
receiving, by a user device from a base station, a control signal indicating that base station-triggered reference signals will be transmitted to the user device;
receiving, by the user device, the base station-triggered reference signals on a set of time-frequency resources in at least one physical downlink control channel (PDCCH) search space;
performing signal processing based on the base station-triggered reference signals.

21. A method comprising:
determining, by a base station in a wireless network, an event;
transmitting, from a base station in response to the event, a control signal indicating that base station-triggered reference signals will be transmitted to the user device;
transmitting the base station-triggered reference signals on a set of time-frequency resources in at least one physical downlink control channel (PDCCH) search space.

22. The method of claim 21 wherein determining the event comprises:
determining that a change in bandwidth between the base station and the user device will be performed by the base station; and
wherein the transmitting the control signal comprises transmitting a bandwidth switching command that indicates a radio frequency bandwidth between the base station and the user device is changing.

23. The method of claim 21 wherein the reference signals comprise demodulation reference signals.

24. The method of claim 21 wherein the control signal is transmitted via downlink control information (DCI) or via a MAC (media access control) control element.

25. The method of claim 21 wherein the control signal indicates one or more time-frequency resources for transmitting the base station-triggered reference signals.

26. The method of claim 21 wherein the control signal indicating the base station-triggered reference signals will be transmitted to the user device is included along with at least one of the following control messages transmitted by the base station:
a message indicating a change in bandwidth between the base station and the user device;
a message indicating a carrier aggregation configuration, reconfiguration or deactivation; and
a message indicating a change in a center frequency for a downlink transmission bandwidth between the base station and the user device.

27. The method of claim 21 wherein the base station-triggered reference signals comprise reference signals that are transmitted via at least one of the following:
pre-defined time-frequency resources of a physical downlink control channel (PDCCH) common search space (CSS); and
pre-defined time-frequency resources of a physical downlink control channel (PDCCH) user device-specific search space (USS) for the user device.

28. The method of claim 21 wherein the transmitting a control signal indicating that base station-triggered reference signals will be transmitted to the user device comprises transmitting a broadcast or group-common message addressed to a plurality of user devices indicating a presence of base station-triggered reference signals on one or more time-frequency resources of a downlink control channel common search space (CSS).

29. The method of claim 21 wherein the receiving a control signal indicating that base station-triggered reference signals will be transmitted to the user device comprises transmitting a user device-specific message addressed to a single user device indicating a presence of reference signals on one or more time-frequency resources of a downlink control channel search space.

30. An apparatus comprising at least one processor and at least one memory including computer instructions, when executed by the at least one processor, cause the apparatus to perform the method of claim 21.
